(19) United States
(12) Patent Application Publication
(10) Pub. No.: US 2008/0223416 A1
(43) Pub. Date: Sep. 18, 2008

(54) METAL CLEANING AGENT AND METHOD FOR CLEANING METAL PARTS

(75) Inventors: HONG-HAI XU, Shenzhen (CN); ZHENG-JIANG REN, Shenzhen (CN); JIANG-RONG DING, Shenzhen (CN); JI-KAI LIU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/860,496

(22) Filed: Sep. 24, 2007

(30) Foreign Application Priority Data
Mar. 16, 2007 (CN) 200710073540.2

(51) Int. Cl. C23G 1/00; B08B 3/10; C11D 3/02; C11D 3/20; C11D 3/34

(52) U.S. Cl. 134/35; 134/41; 510/245

(57) ABSTRACT

A cleaning agent for metal parts (e.g., steel articles) includes sodium hydroxide in an approximate amount of 15 wt % (percent by weight) to 25 wt %, sodium tripolyphosphate in an approximate amount of 6 wt % to 9 wt %, sodium metasilicate in an approximate amount of 48 wt % to 51 wt %, sodium dodecyl benzene sulfonate in an approximate amount of 2 wt % to 5 wt %, sodium carbonate in an approximate amount of 8 wt % to 11 wt %, and alkylphenol polyoxyethylene ether in an approximate amount of 1 wt % to 4 wt %.

### BACKGROUND OF THE INVENTION

1. Field of the Invention

The present invention relates to cleaning agents and, particularly, to a cleaning agent for metal parts.

2. Description of related art

Generally, metal parts which are used in mobile devices such as mobile phones, personal digital assistants and mobile music players, are manufactured by stamping. During the stamping process, the metal parts may come into contact with various contaminants, e.g. lubricants and oils, which are used in stamping punches and stamping molds. Thus, after the stamping process, the metal parts need to be cleaned to remove the contaminants. Cleaning typically involves use of a alkaline degreasing agent. However, conventional degreasing agents are prepared with high cost.

Therefore, an improved metal surface cleaner is desired in order to overcome the above-described shortcomings.

### SUMMARY OF THE INVENTION

In one embodiment thereof, a cleaning agent for metal parts includes sodium hydroxide in an approximate amount of 15 wt % (percent by weight) to 25 wt %, sodium tripolyphosphate in an approximate amount of 6 wt % to 9 wt %, sodium metasilicate in an approximate amount of 48 wt % to 51 wt %, sodium dodecyl benzene sulfonate in an approximate amount of 2 wt % to 5 wt %, sodium carbonate in an approximate amount of 8 wt % to 11 wt %, and alkylphenol polyoxyethylene ether in an approximate amount of 1 wt % to 4 wt %.

Other advantages and novel features will become more apparent from the following detailed description of preferred embodiments.

### DETAILED DESCRIPTION OF THE INVENTION

In a preferred embodiment, a cleaning agent for metal parts (e.g., steel articles) contains sodium hydroxide in an approximate amount of 15 wt % (percent by weight) to 25 wt %, sodium tripolyphosphate in an approximate amount of 6 wt % to 9 wt %, sodium metasilicate in an approximate amount of 48 wt % to 51 wt %, sodium dodecyl benzene sulfonate in an approximate amount of 2 wt % to 5 wt %, sodium carbonate in an approximate amount of 8 wt % to 11 wt %, and alkylphenol polyoxyethylene ether in an approximate amount of 1 wt % to 4 wt %.

The sodium hydroxide should preferably be 28.24 wt % of the surface cleaner. The sodium tripolyphosphate should preferably be 7.06 wt % of the surface cleaner. The sodium metasilicate should preferably be 49.41 wt % of the surface cleaner. The sodium dodecyl benzene sulfonate should preferably be 3.76 wt % of the surface cleaner. The sodium carbonate should preferably be 9.18 wt % of the surface cleaner. The alkylphenol polyoxyethylene ether should preferably be 2.35 wt % of the surface cleaner. These above-described components are inexpensive and can be easily obtained. An aqueous solution of the cleaning agent could be employed for cleaning a steel metal article effectively.

In a preferred embodiment, a method for cleaning surfaces of metal parts by use of the cleaning agent includes following steps.

Firstly, a holding fixture is provided. A plurality of metal parts is placed onto the holding fixture.

Secondly, a cleaning tank is provided. The cleaning tank has an ultrasonic generator and a heating device mounted therein. The ultrasonic generator is used for applying ultrasonic vibrations to an aqueous cleaning agent (i.e., a solution of the cleaning agent) received in the cleaning tank. The heating device serves to maintain a temperature of the aqueous cleaning agent at a predetermined level.

Thirdly, an aqueous solution of the cleaning agent is prepared in the cleaning tank. A method of preparing the aqueous solution of the cleaning agent includes the following steps. Firstly, water is poured into the cleaning tank. Secondly, an appropriate amount of the cleaning agent is added into the cleaning tank so as to obtain a solution of the cleaning agent at a concentration in an approximate range from 3 wt % to 5 wt %. The heating device is then actuated to heat the solution prepared in the cleaning tank and maintain the temperature of the solution within a range from approximately 50° C. to 60° C. In this way, the aqueous solution of the cleaning agent is prepared.

Fourthly, the metal parts with the holding fixture are immersed into the cleaning agent in the cleaning tank. The ultrasonic generator is actuated to induce ultrasonic vibrations to the aqueous solution of the cleaning agent, which will benefit degreasing. The metal parts are treated in the aqueous solution of the cleaning agent for approximately 5 minutes to 7 minutes. Oils or lubricants on the surfaces of the metal parts are then degreased by the cleaning agent.

Fifthly, the metal parts are rinsed in running water, so as to remove the remaining cleaning agent from the surfaces thereof. The rinsing process may be carried out for approximately 10 seconds.

Finally, the metal parts are further rinsed in an aqueous auto-cleaning machine and dried in a drying machine.

A main advantage is that, due to the beneficial composition of the cleaning agent, contaminations (e.g., oils and lubrications) can easily be removed from the surfaces of the metal parts, beneficially of steel parts.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cleaning agent for metal parts, comprising:
sodium hydroxide in an approximate amount of 15 wt % (percent by weight) to 25 wt %, sodium tripolyphosphate in an approximate amount of 6 wt % to 9 wt %, sodium metasilicate in an approximate amount of 48 wt % to 51 wt %, sodium dodecyl benzene sulfonate in an approximate amount of 2 wt % to 5 wt %, sodium carbonate in an approximate amount of 8 wt % to 11 wt %, and alkylphenol polyoxyethylene ether in an approximate amount of 1 wt % to 4 wt %.

2. The cleaning agent as claimed in claim 1, wherein the sodium hydroxide has an approximate amount of 28.24 wt % of the cleaning agent.

3. The cleaning agent as claimed in claim 1, wherein the sodium tripolyphosphate has an approximate amount of 7.06 wt % of the cleaning agent.

4. The cleaning agent as claimed in claim 1, wherein the sodium metasilicate has an approximate amount of 49.41 wt % of the cleaning agent.

5. The cleaning agent as claimed in claim 1, wherein the sodium dodecyl benzene sulfonate has an approximate amount of 3.76 wt % of the cleaning agent.

6. The cleaning agent as claimed in claim 1, wherein the sodium carbonate has an approximate amount of 9.18 wt % of the cleaning agent.

7. The cleaning agent as claimed in claim 1, wherein the alkylphenol polyoxyethylene ether has an approximate amount of 2.35 wt % of the cleaning agent.

8. A method for cleaning surfaces of metal parts, comprising the steps of:
providing a solution of a cleaning agent, the cleaning agent being comprised of sodium hydroxide in an approximate amount of 15 wt % (percent by weight) to 25 wt %, sodium tripolyphosphate in an approximate amount of 6 wt % to 9 wt %, sodium metasilicate in an approximate amount of 48 wt % to 51 wt %, sodium dodecyl benzene sulfonate in an approximate amount of 2 wt % to 5 wt %, sodium carbonate in an approximate amount of 8 wt % to 11 wt %, and alkylphenol polyoxyethylene ether in an approximate amount of 1 wt % to 4 wt %;
immersing the metal parts into the solution of the cleaning agent so as to clean the surfaces of the metal parts; and
rinsing and drying the metal parts.

9. The method as claimed in claim 8, wherein the cleaning agent is received in a cleaning tank, the cleaning tank having an ultrasonic generator and a heating device mounted therein, the ultrasonic generator being actuated to apply ultrasonic vibrations to the cleaning agent, the heating device being actuated to control temperature of the cleaning agent.

10. The method as claimed in claim 8, wherein a concentration of the solution of the cleaning agent is in an approximate range from 3 wt % to 5 wt %.

11. The method as claimed in claim 8, wherein a temperature of the cleaning agent is maintained at a range from approximately 50° C. to 60° C.
